(19) United States
(12) Patent Application Publication
(10) Pub. No.: US 2005/0194049 A1
(43) Pub. Date: Sep. 8, 2005

(54) Oil feeding apparatus of motor vehicle

(75) Inventors: Hiroshi Yoshida, Soja-shi (JP); Kazushige Nishida, Soja-shi (JP)

Correspondence Address: KODA & ANDROLIA, 2029 CENTURY PARK EAST, SUITE 1140, LOS ANGELES, CA, 90067, US

(73) Assignee: Asteer Co., Ltd.

(21) Appl. No.: 11/029,703

(22) Filed: Jan. 4, 2005

(30) Foreign Application Priority Data
Jan. 23, 2004 (JP) 2004-015722

(51) Int. Cl. G05D 7/00

(52) U.S. Cl. 137/592

(57) ABSTRACT

An oil feeding apparatus of motor vehicle comprises a fuel inlet and a fuel tank, which prevents or suppresses corrosion at a portion or a clearance having its passive film becoming hard to be formed, so that it has an excellent corrosion resistance. In a fuel inlet 1 to be assembled with stainless steel members 11, 12 and 13, for example, a sacrifice electrode 2 having a zinc-containing portion is formed at or near a portion required to be preserved by a welding or a brazing when those members are to be assembled, so that the portion required to be preserved is prevented or suppressed by a preferential corrosion of the sacrifice electrode 2 from being corroded.

### BACKGROUND OF THE INVENTION

1. Field of the Invention

The present invention relates to an oil feeding apparatus of motor vehicle, which comprises a fuel inlet and a fuel tank prevented or suppressed from a partial corrosion.

2. Description of the Related Art

An oil feeding apparatus of motor vehicle in recent years including a fuel inlet and a fuel tank is constructed by assembling a plurality of stainless steel members. The stainless steel exhibits an excellent corrosion resistance with a passive film on its surface. However, composition of the members to be assembled by welding or brazing is changed by that, for example, a welding causes decrease share of chrome bonding with carbon and to thereby obstruct formation of the passive film on surface of the members. As a result, the members become facing to risks to be corroded. Moreover, an electrolyte may deposit in the clearance between the members complexly assembled and is concentrated. As a result, the electrolyte may eliminate the passive film in the clearance thereby to cause the corrosion.

JP-A-2002-242779 (U.S. Pat. No. 6,615,489) proposes that a cationic electro deposition put whole fuel inlet can be used to prevent or suppress the corrosion. In JP-A-2003-277992 (U.S. Ser. No. 2003/0183626A), on the other hand, the corrosion is prevented or suppressed by applying zinc-containing paint exclusively to the welded portion of the fuel inlet or fuel tank made of galvanized stainless steel and further by subjecting the same to the electro deposition.

However, the electro-deposited portion may be easily damaged by a chipping (e.g., a collision of pebbles or the like) and may be corroded from the damage. In this respect, the double structure, which is made by applying the zinc-containing paint to the galvanized portion or by overlaying the zinc-containing paint film and the electro deposition, can improve the aforementioned chipping drawback but may invite a problem of an excessive quality or a considerable increase in the weight. Therefore, the inventors have made investigations to provide an oil feeding apparatus comprises a fuel inlet and a fuel tank, which prevents or suppresses corrosion at a portion or a clearance having its passive film becoming hard to be formed, so that it has an excellent corrosion resistance.

### SUMMARY OF THE INVENTION

As a result of the above investigations, the inventors have developed an oil feeding apparatus of motor vehicle comprising a fuel inlet and a fuel tank assembled with a plurality of stainless steel members wherein a sacrifice electrode having a zinc-containing portion is formed at or near a portion required to be preserved arising when the members are assembled, so that the portion required to be preserved is prevented or suppressed from corrosion by a preferential corrosion of the sacrifice electrode.

Here, the portion required to be preserved means the portion having its passive film becoming hard to be formed by a welding or brazing, or the clearance formed when the members are assembled.

In this portion required to be preserved, the stainless steel is exposed as it is to the outside, and the sacrifice electrode is spotted on the portion instead of covering by the passive film. On the contrary, the sacrifice electrode may be formed near the portion required to be preserved where the passive film is still left on the portion.

The sacrifice electrode corrodes preferentially of the portion of stainless steel required to be preserved, and thereby prevents or suppresses, as a reflective action, the corrosion of the portion required to be preserved. Therefore, the sacrifice electrode may be formed not only at the portion required to be preserved but also near the portion required to be preserved. The sacrifice electrode may be sized to match the portion required to be preserved. Therefore, the periphery of the sacrifice electrode is still made of the stainless steel so that the sacrifice electrode is exclusively liable to corrode preferentially of the portion required to be preserved. As a result, the portion required to be preserved is easily prevented or suppressed from corroding.

The specific sacrifice electrode can be made to have various structures. The simplest sacrifice electrode is the paint film of zinc-containing paint, which is applied to or near the portion required to be preserved. The zinc-containing paint is preferred to have a zinc content of 50% or more of the principal component of the paint. This sacrifice electrode made of the paint film is suitable for the case, in which the portion required to be preserved can be observed from the outside.

Moreover, the firm sacrifice electrode is a zinc-containing plated layer, which is formed at or near the portion required to be preserved. Unlike the sacrifice electrode made of the paint film, the plated layer can be integrated with stainless steel to provide such a sacrifice electrode as does not easily exfoliate.

In case it is difficult to apply the paint or to form the plated layer, the sacrifice electrode may be made of a zinc-containing sheet, which is adhered or clamped to the portion required to be preserved. In this case, (a) the zinc-containing sheet is prepared by forming a zinc-containing plated layer on the surface of a metal sheet having flexibility, or (b) the zinc-containing sheet is prepared by introducing zinc into a resin sheet having flexibility. These zinc-containing sheets are sandwiched in advance between the contact faces when the members are to be assembled.

In addition, the sacrifice electrode may be a zinc-containing member, which is fixed to or near the portion required to be preserved. Concretely, a rivet, a screw, a bolt or the like made of a zinc alloy. In case these zinc-containing members are fixed to or near the portion required to be preserved, a through portion is formed. Therefore, this sacrifice electrode made of the zinc-containing member is suitable for such a portion as requires neither water-tightness nor air-tightness.

In the oil feeding apparatus of the present invention, at the portion which is not subjected to the welding or brazing when the stainless steel members are assembled, the corrosion resistance intrinsically owned by stainless steel is exhibited so that the portion required to be preserved is enabled to retain the corrosion resistance by the sacrifice electrode. Here, the sacrifice electrode shares only a portion so that it does not result in an excessive quality or a substantial increase in the weight and so that it can suppress any cost rise. That is, the present invention can provide an oil feeding apparatus being excellent in cost-effect to retain the total corrosion resistance.

### BRIEF DESCRIPTION OF THE DRAWINGS

FIG. 1 is a general perspective view of a fuel inlet, which is applied the invention.

FIG. 2 is an end elevation taken on line A-A in FIG. 1.

FIG. 3 is an end elevation showing another embodiment corresponding to FIG. 2.

### DETAILED DESCRIPTION OF THE INVENTION

An embodiment of the invention will be described by exemplifying a fuel inlet 1.

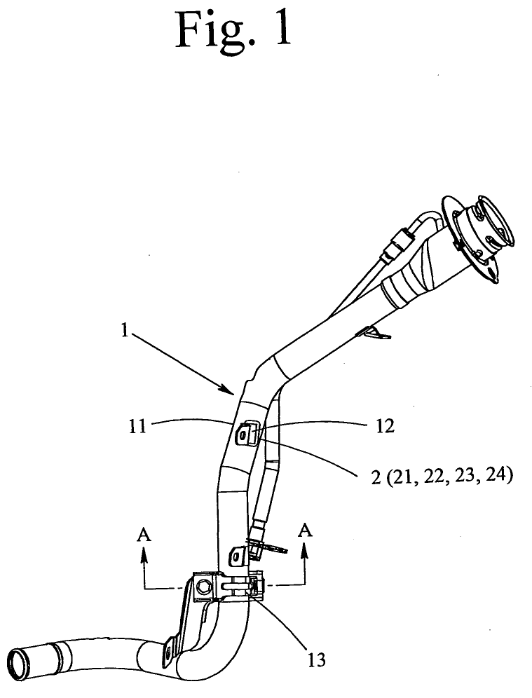

As apparent from FIG. 1, the fuel inlet 1 is composed of a plurality of stainless steel members 11, 12 and 13. A welding or a brazing to one another of the members causes hardness to form the passive films on surfaces of the stainless steel members 11, 12 and 13, or to form clearances. Therefore, a sacrifice electrode 2 is formed corresponding to the portion required to be preserved, in the following manners.

At the portion where the bracket 12 is fixed on the fuel inlet body 11 by a welding or a brazing, as shown in FIG. 1, the sacrifice electrode 2 is formed by applying zinc-containing paint to that portion to form a zinc-containing paint film 21 or a partial zinc-containing plated layer 22. The bracket 12 is usually welded around the portion in face-to-face contact with the fuel inlet body 11 so that the clearance, through which the portion required to be preserved is partially hidden by the bracket 12, is frequently formed. The sacrifice electrode 2 is formed by penetrating the zinc-containing paint to the clearance hidden by the bracket 12.

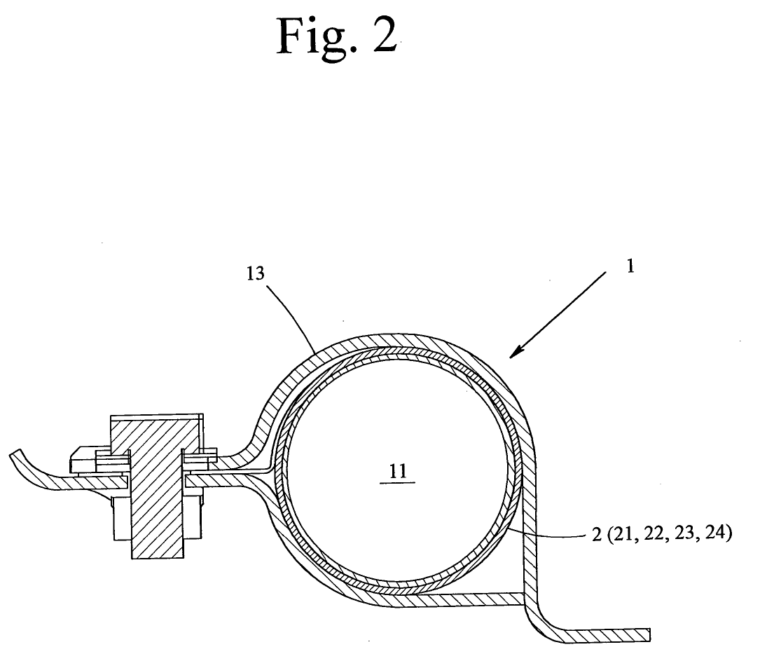

Next, at the clearance which is formed by fixing the bracket 13 to the fuel inlet body 11 by caulking or fastening those members to each other, as shown in FIG. 2, the sacrifice electrode 2 is formed by sandwiching and clamping either a zinc-containing sheet 23 having a zinc-containing plated layer on the surface of a metal sheet or a zinc-containing sheet 24 having a flexible resin sheet containing zinc between the fuel inlet body 11 and the bracket 13. These zinc-containing sheets 23 and 24 can be adhered to the portion required to be preserved by using an appropriate adhesive, instead of using the aforementioned zinc-containing paint or zinc-containing plated layer.

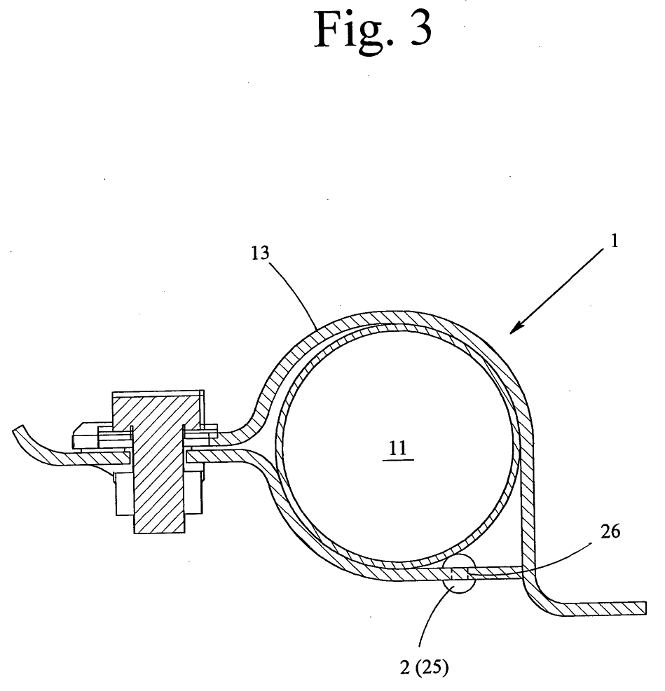

As shown in FIG. 3, on the other hand, a zinc-containing member such as a rivet 25 may be fixed no matter how it shapes of either the portion or the clearance including passive film becoming hard to be formed. In this case, there is formed a through hole 26, which is necessary for fixing the rivet 25. It is, therefore, advisable to fix the rivet 25 on a member such as the bracket 13 other than the fuel inlet body 11 and to bring a portion of the rivet 25 into contact with the portion of the fuel inlet body 11 required to be preserved. Further, the bracket 13 having the zinc-containing plated layer may be used so that the fuel inlet body 11 can display a remarkable effect of corrosion resistance.

1. An apparatus for feeding oil comprising a fuel inlet and a fuel tank assembled with a plurality of stainless steel members,
wherein a sacrifice electrode having a zinc-containing portion is formed at or near a portion required to be preserved arising when members are assembled, so that the portion required to be preserved is prevented or suppressed from corrosion by a preferential corrosion of the sacrifice electrode.

2. An apparatus for feeding oil according to claim 1,
wherein the portion required to be preserved is the portion having, a passive film becoming hard to be formed by a welding or a brazing.

3. An apparatus for feeding oil according to claim 1,
wherein the portion required to be preserved is the clearance, which is formed by assembling the members.

4. An apparatus for feeding oil according to claim 1,
wherein the sacrifice electrode is a paint film of zinc-containing paint, which is applied to or near said portion required to be preserved.

5. An apparatus for feeding oil according to claim 1,
wherein the sacrifice electrode is a zinc-containing plated layer, which is formed at or near said portion required to be preserved.

6. An apparatus for feeding oil according to claim 1,
wherein the sacrifice electrode includes a zinc-containing sheet, which is adhered or clamped to said portion required to be preserved, and the zinc-containing sheet is prepared by forming a zinc-containing plated layer on the surface of a flexible metal sheet.

7. An apparatus for feeding oil according to claim 1,
wherein the sacrifice electrode includes the zinc-containing sheet, which is adhered or clamped to said portion required to be preserved, and the zinc-containing sheet is prepared by introducing zinc into a flexible resin sheet.

8. An apparatus for feeding oil according to claim 1,
wherein the sacrifice electrode is a zinc-containing member, which is fixed to or near said portion required to be preserved.
